(19) United States
(12) Patent Application Publication
(10) Pub. No.: US 2021/0322278 A1
(43) Pub. Date: Oct. 21, 2021

(54) User controllable non-collapsable variable stream patterned nipple

(71) Applicants: Craig E. Brown, Shelbyville, IL (US); Robert J. Brown, Chesterfield, MO (US)

(72) Inventors: Craig E. Brown, Shelbyville, IL (US); Robert J. Brown, Chesterfield, MO (US)

(21) Appl. No.: 16/350,274

(22) Filed: Oct. 25, 2018

(51) Int. Cl. A61J 11/00; A61J 9/04; A61J 11/04

(52) U.S. Cl. CPC A61J 11/0015; A61J 11/04; A61J 11/005; A61J 9/04

(57) ABSTRACT

A flow controllable and variable stream physiological dispenser for nursing and related bottle, including a nursing bottle, or a sports container, having a cap holding a nursing bottle nipple, or a spout, upon its upper end, the bottle or container may have a singular or double venting structure provided therein, so as to prevent aeration of its contents and eliminate the need for sucking pressure to attain fluid flow from the container. The nipple or spout has various slits, of varying lengths, in order to regulate the quantity of flow of liquid from the bottle, and which nipple may be reinforced through internally formed ribs. Indicia is provided for indicating a fast, intermediate, or slow rate of flow of formula from the bottle, and various apertures, slits, crosscuts, tangential cuts, may be provided at the apex of the nipple or spout to provide a standard constant flow of fluid from the associated container, and which may be supplemented through the flow of formula through the associated radial slits provided through the upper reaches of the nursing bottle nipple or spout.

### CROSS REFERENCE TO RELATED APPLICATION

This application is a continuation-in-part of the letters patent application having Ser. No. 14/544,773, filed on Feb. 18, 2015, now U.S. patent Ser. No.______, which latter application claims priority to a provisional patent application having Ser. No. 61/966,292, filed on Feb. 18, 2014; and this application is a continuation-in-part of the design application having Ser. No. 29/620,662, filed on Apr. 11, 2017, which latter application is a continuation-in-part of the design application having Ser. No. 29/505,428, filed on Oct. 29, 2015, now abandoned; and this patent application claims priority as a continuation-in-part of the design patent application having Ser. No. 29/620,663, filed on Apr. 10, 2017; and the latter application claims priority as a continuation-in-part of the patent application having Ser. No. 29/474,759, filed on Jan. 29, 2015, now abandoned; and this patent application claims priority as a continuation-in-part of the design patent application having Ser. No. 29/620,664, filed on Apr. 11, 2017, and which latter application claims priority as a continuation-in-part upon the design patent application having Ser. No. 29/505,029, filed on Apr. 30, 2015, which latter application is now abandoned.

### FIELD OF THE INVENTION

This invention generally relates to a nipple for use upon a nursing bottle, and more particularly to a user controllable non-collapsible variable stream nipple for use upon a nursing bottle, or a related container.

### BACKGROUND OF THE INVENTION

Infants need to consume liquids every day in order to prevent dehydration, and to receive sustenance, particularly during the early years. The same can be said for humans, that need to consume liquids daily, and particularly those that participate in various strenuous events, such as jogging, running, sports, and the like. The consumption by both groups of a significant amount of water or other liquids are essential.

Any significant loss of fluids, by people, is magnified with an elevated temperature, or anything else that causes fluid loss from the body. Individuals of all ages consume liquids from containers, as is well known.

The feeding nipples on nursing bottles that infants use contain one or more apertures for liquid delivery. Usually, such apertures simply provide for a delivery of a fixed amount of liquid, per time period. Such feeding nipples frequently contain holes or other apertures for liquid delivery, and which are not exactly as advertised, thus such nipples can cause further feeding problems. Some flow formulas too freely, and others require too much sucking by the infant, to attain consumption. Both can cause problems for the infant, and such apertures frequently do not dispense at a predictable rate. Dispensing of liquid may be inconsistent, too rapid, or too slow. The deliver of liquid in such inconsistent rates is a problem when the liquid is being delivered to small infants, and particularly to the very small premature infant.

The inventors, herein, early recognized the problems associated with the feeding particularly of infants, where the fluid flowing from the nursing bottle flows out too quickly and leads to choking or spilling of liquid on the infant. If an infant uses a nipple that releases liquid too quickly then the infant can choke or even aspirate the formula. This can lead to pneumonia or suffering of another medical sequela. Occasionally, the individual may want to consume liquid at a faster flow rate. However, because the aperture of the dispensing mechanism is too small, this may not be possible. If the dispenser delivers the liquid too slowly, then the user, particularly an infant, can suck so vigorously that air is ingested into the gastrointestinal track from around the dispenser or nipple during sucking, with adverse results.

Generating aeration within the formula, due to infant sucking, can lead towards bubbles being consumed by the infant through the formula, which can lead towards gastric problems. And, heavy sucking upon the nipple can cause ear problems, such as ear infection, for the infant.

The inventors herein recognized the problems associated with the consumption of formula particularly by the infant, and have provided means for remedying such predicaments, as can be noted in their early U.S. Pat. No. 5,779,071, upon a nursing bottle with an air venting structure, in addition to U.S. Pat. No. 5,570,796, upon a related type of nursing bottle. Essentially, as noted in these two patents, the concept was to provide for venting within the bottle, so the infant would not need to do any sucking, or excessive sucking, to obtain a flow of the bottled contents through the nipple, and in addition, the interior and contents of the bottle would be totally vented, so as to prevent aeration from being generated within the formula, during sustained consumption. The contents of these two prior patents are incorporated herein by reference, as a basis for explaining the advantages of a vented, or double vented, nursing bottle, when used.

If a nipple being employed is found to be unsatisfactory, or does not deliver the formula at the rate desired by the infant, then the nipple must be changed and feeding has to be tried again. This process may have to be repeated a few times, until a nipple having a desired flow rate is obtained. In addition, infants also require changed feeding speeds frequently as they grow, and this can only be done through changing of the nipples, on the nursing bottles, and through a trial and error practice. The current disclosure obviates this procedure. Another common problem associated with the use of a nipple is the nipple collapsing during use or sucking by the infant. Nipple collapse does not occur during breastfeeding. However, nipple collapse with use of an artificial nipple can impede feeding and be frustrating to the infant. Also, the nipple may easily be compressed, which results in the dispenser becoming unusable.

If a container spout is used, one or more new containers have to be obtained and tried. If an adult is using a sports bottle with the typical vertical spout, the bottle has to be removed from the mouth and readjusted until the rate of flow of the liquid becomes satisfactory.

As known, infants feed much more easily and efficiently when breastfeeding. It is also known that usage of the applicants' vented continuously positive pressure bottles can feed an infant similar to breastfeeding. There are several reasons for this. It is known that breast milk is ejected with a positive pressure. This is why women have to wear breast pads in-between feeding. The applicants' bottle provides the feeding liquid with a positive pressure during the entire feeding process. This is quite advantageous.

When current nipples and apertures are used, which are of the standard type, the flow characteristics of the nipple cannot be modified or adjusted by the infant. Further, producing nipples having a uniformly very small aperture is extremely difficult to employ. Furthermore, of note, is that the current slits presented in some nipples, which are called “cereal nipples” or “juice nipples”, exhibit an inconsistent pattern. The flow may be significantly too rapid with the slits oriented in one direction. When the slits are oriented in another direction, there is frequently no flow. This is a particularly significant problem with newborns and smaller infants because they require controlled and controlled flow rates. If the flow is too rapid, then they can choke, gag, and aspirate the liquid formula. On the other hand, if the flow is too slow, then they do not obtain enough nourishment, and it causes the infant to suck even harder, inducing the type of problems as previously referred to. This causes infant and caregiver frustration and should be avoided.

The flow rate provided by the standard nipples is unphysiological for multiple reasons. Normal breast milk is ejected from the breast with a positive pressure and is under control of the infant during feeding. This is demonstrated during feeding and all other times, since, as stated, women frequently have to wear breast pads to remain dry. All of the known nipples have a negative pressure and dispensers do not even allow for the infants to control the flow. The liquid is regulated by the negative pressure of the container and the size of the aperture in the nipple.

In addition, breast milk and formula which are a valuable commodity, and very expensive, are both sensitive and subject to nutritional breakdown, especially over time if exposed to unphysiological amounts of elements, such as air. In particular, air that is allowed into a container may degrade vitamins C, A, E and Lipids, and may affect other essential components of nutrition. The contamination of the liquid through one or more holes also introduces air into the liquid, and stomach, and the rest of the gastrointestinal tract, which may lead to gas, bloating, vomiting, colic, fussiness, and other infant maladies. Also, nipple confusion may easily occur typically due to collapsing of the nipples, excessive sucking pressures needed by the infant, air passing through and around the nipple, vacuum not being relieved by the nipple arrangement, irregular and unregulated fluid flow, and other etiologies.

With known prior art unphysiological nipples and other dispensers, along with their containers, a large vacuum must be generated in the oral cavity of the infant and that vacuum must be transmitted through the nipple of the container. The need to generate this large vacuum is another non-physiological aspect of the known bottles and nipples. This can cause abnormal mouth, including tooth development, and ear and hearing problems, with their attendant developmental delays, and also ear fluid and infections.

When a fully vented container is used, in order to simulate normal breast physiology, and a positive pressure is present in the container, fluid is released similarly to the breast for the first time. Since there is a positive pressure, but no ducts and sphincters, as are present in normal breast milk ducts, to regulate the flow of liquid, the fluid exits the container very quickly, even when small holes are used in the nipple. Historically, these holes were lasered, punched, and molded into the nipple. However, a hole that was imprecise very frequently resulted in feeding times that were significantly too long. Further, if the hole is too large, then the infant might choke on the feeding liquid. The liquid may even dispense so quickly as to pour out of the mouth, as frequently occurs. Also, the orientation of the nipple and the bottle may change during feeding and result in very slow feeding in one position and very rapid feed in another position or even change during feeding in the same position. This is obviously very frustrating, uncontrollable, and unphysiological. To compensate, the hole was purposely made too small in an effort to reduce flow to the infant so that the infant did not receive too much liquid at any time. This problem occurs with all dispensers, for all ages, but is exponentially worse with smaller infants due to their extremely small oral cavities. In light of this, manufacturers frequently made one hole at a smaller drip rate than desired for use. This resulted in feedings frequently lasting more than forty-five minutes, which is much longer than normal breast feeding. Another problem encountered with the fully vented containers is that of forceful streams of liquid coming out of the container. This stream of fluid can easily choke an infant, especially if placed in the center of the nipple or dispenser, where it can easily be aspirated and cause medical problems, especially in the infant. Also, the infant cannot squeeze the feeding nipple like the nipple of the breast, in a variable pattern, and control the flow of liquid from the breast in a predictable manner.

When breastfeeding, the infant can put pressure on the milk ducts from the proximal to distal breast and can also generate a physiologically small amount of negative pressure in the mouth when more milk is needed. The milk ducts of the breast and the nipple will release more milk due to these negative pressures generated by the infant. However, present nipples do not allow for any regulation of the flow of liquid through the feeding nipple by the infant.

Bottles are frequently squeezed and turned upside down by infants, at all ages, and cause a mess. This is due to the holes that are currently used in the nipples. A dispenser that does not leak or cause a mess would be desirable. The present disclosure, as was further added to by the patented design of the applicants herein, are designed to obviate and overcome many of the disadvantages and shortcomings experienced with the prior nipple dispensing devices.

The present disclosure is related to a user controllable non-collapsible variable stream physiological dispenser for use with a nursing bottle, or even with a sports bottle, where desired. It would be desirable and advantageous to have a nipple dispenser that does not collapse during usage. It would also be beneficial to have a nipple dispenser that can be used with a vented container to prevent any air from contaminating the liquid or formula stored therein.

Other United States patents obtained by the inventors herein, include U.S. Pat. Nos. 8,757,406; 8,579,130; 8,479,934; and U.S. Pat. No. D725,787. In addition, further patents include U.S. Pat. No. 8,146,759; 8,113,365; 7,828,165; and D549,833. These are examples of improvements made by the inventors herein, to nursing bottle structures.

In addition, other prior art known relating to nipples, nursing bottles, and other drinking products, include U.S. Pat. Nos. 6,994,225; 3,134,495, showing a cross-hatch type of nipple dispensing; U.S. Pat. No. 2,223,179, showing the use of equal slits upon the upper portion of a nursing bottle nipple; U.S. Pat. Nos. 3,139,064; 5,117,994, upon a variable-flow feeder; and, 158,075.

The present disclosure is designed to obviate and overcome many of the disadvantages and shortcomings experienced with prior nipple dispensing devices. The present disclosure is related to a user controllable non-collapsible variable stream physiological dispenser for use with a bottle, such as a nursing bottle. It would desirable and advantageous to have a nipple dispenser that does not collapse during usage, and which can provide for a variable flow at the selection of the mother or feeder, and also allow the infant to regulate the flow. It would also be beneficial to have a nipple dispenser that can be used with a venting container, to prevent any air from contaminating the liquid or formula stored in such a container.

Also, the current invention is the first to allow both the caregiver and infant, or user for a sports bottle, to adjust the flow as needed, in real time. The nipples of breastfeeding women have a range of 3-13 apertures and a system of glands and ducts supplying milk. This nipple is the first to simulate breast physiology.

### SUMMARY OF THE DISCLOSURE

The concept of this invention is to provide a variable stream type of flow nipple for use upon a nursing bottle, and one that has predetermined slits provided upon the nipple so as to allow the mother or caregiver to reasonable control the dispensing of milk or formula to the infant, during feeding. For the variety of reasons previously reviewed in the Background of the Invention, it is desirable to be able to control the quantity of formula being dispensed, depending upon the maturity of the infant in being able to consume either lesser amounts, or larger amounts, of the formula being delivered, so as to avoid the imparities that can be generated in the physiology of the infant, if too much or too little of formula is being dispensed, from the nursing bottle.

In addition, the concept of this invention could also be used with a sports bottle, so that those using such a bottle, for dispensing water, or other liquids or fluids, can be assured that adequate amounts of the fluids are being dispensed, with little or no aeration, due to vessel venting, so as to prevent the athlete or others from developing too much air in the stomach, which may impair their performance. The flow could also be adjusted in real time, for the first time.

In one form of the present disclosure, a user controllable non-collapsible variable stream physiological dispenser for a container is disclosed and which comprises a feeding nipple, having a top nipple portion, that extends to an intermediate concaved section, as known in the art, and which extends to a lower dome-shape body and integrally into a flange for mounting upon a container. The flange is used to hold the nipple onto the bottle, by a collar, with the nipple having openings formed in the top nipple portion, an open bottom provided at the flange part, and with the nipple having a hollow body through which liquid may pass from the open bottom through the body and out of its openings.

In another form of the present invention, a user controllable variable stream dispenser for a vented container does comprise a nipple or spout, with regulated openings provided at the tope of the nipple spout, and which container is vented for the purpose of preventing aeration of the liquid, as it is being dispensed.

In still another form of the present disclosure, the top nipple portion has designed slits, and perhaps even an opening, with the slits being formed to particular lengths, so that when slits of shorter length are inserted through the nipple into the mouth of the feeding infant, and the shorter slits are arranged downwardly, a lesser flow of formula will be dispensed into the infant, during a feeding. But, the other sides of the nipple may have one or more slits of longer length, so that when those nipple slits are oriented downwardly in the mouth of the infant, by turning of the nursing bottle approximately 180 degrees, or for other degrees, to attain a greater flow of formula will be dispensed into the mouth of the infant, during a feeding cycle. Much of this depends upon the maturity of the infant, in being able to accommodate either a lesser amount, or a greater amount, of the formula being dispensed, depending upon the ability of the infant to draw formula from the nursing bottle, during a feeding.

In still another form of the present disclosure, the nipple portion of the nursing bottle may have one or more internally arranged ribs, that span from the bottom to the top of the nipple portion, interiorly thereof, with the rib(s) provided for preventing the nipple from collapsing during usage.

In light of the foregoing comments, it will be recognized that the present disclosure provides a user controllable non-collapsible variable stream physiological dispenser for use with a container, such as a nursing bottle.

This nursing bottle can be employed by the mother, or caregiver, and can be easily used with highly reliable results.

When providing nutrition to an infant, it is important to provide the nutrition in a physiological, pleasing and stimulating manner. In order to provide liquid or formula physiologically to infants, it is beneficial to provide a positive pressure to the liquid so that it is spontaneously released, and such release may be enhanced by the suction provided by the infant. This is exactly what physiologically occurs, as previously explained, when the infant is breast feeding. When the contents of the container or bottle are under positive pressure, especially a thin liquid such as a feeding liquid for infants, even a very small aperture in the container can result in extremely fast and copious release of liquid from the nursing bottle. This may be too much for the infant to handle. This may result in the infant choking and loss of liquid from the mouth of the infant and the container. Physiological release may also be desirable with other releases of the contents of the container.

The present disclosure relates to a nipple with one or more variable sized and variably placed infant or other user controllable leak-resistant apertures for the release of the contents of the container. If desired, the apertures can be patterned so that the infant or user can rotate the container, to some degree, to change the flow of the liquid contents of the container, during usage. Also, the apertures may be angled with respect to the surface of the nipple to control the flow from the container. The apertures may be oriented such that flow patterns are consistently able to be regulated on demand, for the first time, regardless of the orientation of the container, initially. The apertures may be positioned so that one or more are relatively vertical, and may be of different lengths, and located at opposite or different angular positions upon the nipple, so that either a slow flow of liquid, or a faster flow of liquid, can be released from the nursing bottle, depending upon the orientation of the nursing bottle, and its nipple, when the latter is applied into the mouth of the infant, during a feeding cycle.

In addition to the foregoing, and to further enhance flow of liquid from the bottle, a form of aperture may be provided at the top center of the nipple; whether it may be a round aperture, a crosscut, a double crosscut, or a tangential crosscut, provided at that upper central segment of the nipple when formed.

It has been found through experimentation, that when a single slit is provided vertically upon the nipple, and that slit has a length of between 1-2 mm in design, that this provides for a slower delivery of the formula from the nursing bottle, when a single slit of that length is located at the bottom of the nipple as oriented within the mouth of the infant. It has been found that utilizing a slit upon the nipple of approximately that dimension, the slow rate of flow will be approximately 20-30 drops per minute. When three slits of equal size but of that defined length are provided along just one side of the formed nipple, it was found that approximately eighty drops per minute can be dispensed from the nipple. But, when a slit of approximately 2-2.5 mm is provided upon the opposite side of the same nipple, and that slit, within the nipple, is oriented within the bottom part of the infant's mouth, that the formula may be dispensed at approximately 40-50 drops per minute, from that type of a formed nipple. And, where three such slits of that length, and parallel arranged, vertically upon the side of the nipple, below its upper center, as formed in the nipple, and oriented in the bottom of the infant's mouth, that approximately 144 drops per minute can be attained. Hence, when one views the style of nipple having various defined slits as shown in FIGS. 12-14 of the drawings, these types of flows can be attained depending upon the orientation of the nursing bottle, as held by the mother, and which of the shorter or longer slits are disposed towards the bottom of the infant's mouth, during a feeding session.

Thus, control can be provided in the amount of formula to be delivered from the nursing bottle by the mother or caregiver themselves, depending upon the orientation of the nursing bottle relative to the feeding infant. Most mothers explain that they wish to complete an infant feeding in a time span of approximately 15 to 20 minutes, and such can be achieved by utilizing the longer defined slits, within the nursing bottle, as previously defined. When the slower feeding is sought, where the slits are provided in the 1-2 mm range, it may take some 15 to 30 minutes, or longer, to complete a feeding cycle, of approximately four ounces of milk.

As also explained, it is desirable to combine the nipple of the present disclosure when formed in the manner as explained herein, with a single or double venting mechanism, that prevents air from mixing with the contents of the container. A single venting mechanism contains a venting tube leading from the superior aspect of the container to the inferior or bottom aspect of the container. The double venting mechanism consists of a flange on the inferior aspect of the container closure, which accepts the liquid reservoir and its attached and venting tube which extends to the bottom of the container. The closure also has an internally directed venting tube, which extends into the center of a venting reservoir, and with the closure containing an aperture through its wall in contact with the above internal venting tube, allows for the continuous venting from the atmosphere to the inferior aspects of the container, particularly when inverted during feeding. All of these types of venting mechanisms allow for continuous, automatic and on-demand venting of the container. Many of these are shown in the earlier patents to the inventors herein, as previously explained in the Background.

When this invention is used for an infant, the texture of the nipples may be a soft material, such as silicone, used for infant feeding nipples. A firmer material, such as a spout for a drinking cup or sports bottle, as may be used with older persons, may also be used for this invention. The nipple like dispenser, or variable spout, of the present disclosure may also be used with a sports bottle. The aperture may be located in any position upon the nipple, or a spout. A rib may be internally provided that extends longitudely in the nipple, and which prevents its closure or collapsing during usage. The nipple for the bottle may also have a cover for maintaining the hygiene of the dispenser when not in use.

The slit or slits are provided through the surface of the nipple of the present disclosure and are located somewhat distally, as can be noted in the drawings, from the traditional dispensing center of the nipple. The slits may be perpendicular or tangential in nature and orientation. It has been found that if a slower flow is desired, then the slits may be tangentially formed. This means they are cut on an angle, rather than perpendicularly through the structure of the nipple. The tangential slits provide a smaller aperture than compared to slits that are perpendicular to the surface of the nipple when compressed. Due to the small size of the aperture when the slits are tangential, a slower physiological gripping or streaming of liquid is produced. Also, the apertures or slits are larger and more easily manufactured than currently available apertures, which, in the standard nipple, are approximately 0.012 in. This is particularly useful when the material used to construct the nipple dispenser of the present disclosure is a food grade silicone which is very difficult to produce apertures, due to its physical nature. Furthermore, any configuration, shape, combination, and number of apertures may be used, and when coupled with the tangential nature of the apertures, an infinite number of flow characteristics and speeds are possible and obtainable. For example, the apertures may be arranged intersecting each other, which allows for even more combinations of flow. The essence of the invention, though, is to provide a variable flow, that the mother can control, simply through the angular orientation of the nursing bottle, when fitted within the infant's mouth, during a feeding session.

The degree of the tangential cut of the slits to their surface allows for variable and adjustable formed streams and adjustable flow characteristic patterns for the liquid exiting the nipple. The tangential pattern may be made so as to produce liquid that exits in a helical pattern, a pulsing pattern, liquid that exits and clings to the nipple for a short distance, a fine mist of liquid or spray, or multiple other patterns. The desired patterns and amount of flow is quickly and easily selectable by the user by rotating the position of the dispenser or the nursing bottle, and the infant may also change the pattern and flow amount by compressing the dispenser by different amounts and in different places with the tongue, lips, and other portions of the oral cavity. This is similar to breast feeding from the mother, for the first time.

In another embodiment, another useful pattern consists of various slots, generally parallel arranged, select slots being of a short dimension, such as 2 mm long, circularly arranged in close proximity along one upper end of the nipple, while another pattern of slots consists of a series of slots, typically approximately 2.8 mm in length, that may be located diametrically along the opposite side of the nipple, when formed. When the slots are symmetrically placed, the flow is similar in any position and typically flows approximately one to three drops per second, as previously noted. When the slits are asymmetrically arranged, such as the longer slits being located on an opposite side of the nipple, there may be a flow of two to three drops per second. In this way, the flow rate of the formula from the bottle can be easily controlled by the mother. Furthermore, various indicia may be imprinted upon the bottle, or even on the sides of the nipple, to indicate the desired flow rate. For example, on the short slot side of the nipple, there may be indicia that indicates a slow rate of flow of formula. When the type of indicia that be applied on the opposite side of the nipple, in proximity with the longer length of slots, there may be indicia indicating a more rapid or faster flow rate of formula, from the bottle, when used. This depends upon the orientation of the nipple when delivered to the infant's mouth.

A particular useful pattern is one that consists of three parallel apertures, slightly distal to the traditional upper center aperture of the nipple. The three apertures all are vertically oriented, and generally horizontally arranged, relative to one another. This type of arrangement for the slots may be provided on one side of the nipple, while the lengthier similar slots may be provided on the opposite side of the nipple, as explained, and shown in this application. These arrangements provide for consistently regulated infant flow patterns, of formula, in all positions of the bottle. A further desirable pattern comprises apertures or slits of varying lengths with the longest slit being substantially opposed to the shorter slit to control the flow rate from the fastest flow rate to the slowest flow rate, from the nursing bottle nipple. In particular, the fastest flow rate may be about that one ounce per minute, and the slowest flow rate may be about that once ounce per minute and 45 seconds, as previously explained.

These and other advantages of the present disclosure will become more apparent to those skilled in the art after considering the following detailed specification in conjunction with the accompanying drawings.

### BRIEF DESCRIPTION OF THE DRAWINGS

In referring to the drawings,

FIG. 1 provides an isometric view of a nursing bottle with a nipple providing flow control and variable stream dispensing of the bottle contents;

FIG. 1A is a cross-sectional view of a variation upon a vented cap structure showing a spout for use upon a nursing bottle, sports bottle, or related type of container;

FIG. 2 is a top plan view of a nipple showing means for providing a variable stream for flow of formula from a nursing bottle, with the short slits providing for slow flow, and the longer slits providing for a fast flow of the bottle contents;

FIG. 3 is a front view of the variable flow nipple of FIG. 2;

FIG. 4 is a back view of the variable flow nipple of FIG. 2;

FIG. 5 shows a variation upon the patterned slits provided upon the nursing bottle nipple, for providing slow flow, fast flow, and intermediate flow of the bottle contents;

FIG. 6 is a front view of the variable flow nipple of FIG. 5;

FIG. 7 is a back view of the variable flow nipple of FIG. 5;

FIG. 8 is a plan view of the variable flow nipple, providing for fast and slow flow of the bottle contents, and having an upper aperture provided for further flow of formula from the bottle;

FIG. 9 shows a plan view of a modification to the slit arrangement for the shown nipple, having a cross-cut provided upon the top of the shown nipple;

FIG. 10 is a plan view of a further modification to the variable flow nipple, showing a crosscut, cut upon a tangent, at the top of the shown nipple, for providing formula flow from the nursing bottle;

FIG. 10A shows a plan view of a modified nipple disclosing the tangential cut of the cross slits provided at the top of the shown nipple;

FIG. 11 shows a top view of a variable flow nipple, having a series of different length slits, and a crosscut provided upon the top of the shown nipple;

FIG. 12 discloses a top view of a nursing bottle nipple wherein there are a series of short slits, and a series of long slits, generally provided diametrically arranged upon the upper portion of the shown nipple;

FIG. 13 is a left side view of the variable flow nipple FIG. 12;

FIG. 14 is a right side view of the variable flow nipple of FIG. 12;

FIG. 15 provides an isometric view of a nursing bottle nipple having various length of slits provided upon the upper portion of the nipple to furnish various flow rates of formula from the nursing bottle during usage;

FIG. 16 is a top plan view of the nipple of FIG. 15;

FIG. 17 is a front view of the nipple of FIG. 15;

FIG. 18 is a back view of the nipple of FIG. 15;

FIG. 19 is a plan view of a further modification to the variable flow nipple, of FIG. 15, and showing a fluid flow aperture provided upon the upper tip of the shown nipple;

FIG. 20 is an isometric view of a further modification to the variable flow nipple of FIG. 15, and having a crosscut slit provided upon its upper apex;

FIG. 21 provides a top plan view of the nipple of FIG. 20;

FIG. 22 discloses a top plan view of the nipple of FIG. 15, and showing a double crosscut slit provided upon its upper apex;

FIG. 23 is a modification to the nipple of FIG. 22, and having reinforcement internally provided for the nipple to reinforce it against collapse during repeat usage; and

FIG. 24 discloses the nipple having variable slits, of short, long, and intermediate lengths, for use for providing variable flow from the nipple in either the range of a slow, fast, or intermediate flow rates, as can be understood.

### DETAILED DESCRIPTION OF THE PREFERRED EMBODIMENTS

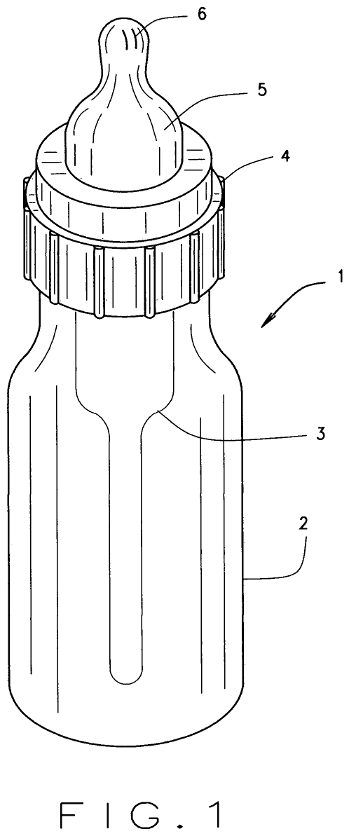

In referring to the drawings, as can be seen in FIG. 1, the nursing bottle 1 of this invention is of the currently standard type, generally as previously reviewed with respect to the applications' prior U.S. Pat. No. 5,779,071. It includes its container 2, the venting structure 3, as previously reviewed, a cap and collar 4, and the baby bottle nipple 5, as noted. What is different about the disclosed device, is the particular arrangement of the various slits 6 provided through the nipple, and which will be subsequently explained in greater detail, to provide for enhancement in the flow of formula or milk from the bottle during an infant feeding session. As noted, there are three lengths of slots noted at 6, although it is just as likely that in the preferred embodiment there may be one, two, three, or perhaps even more, as will be subsequently explained.

As noted in FIG. 1A, the concept of the invention, including a collar and cap 7 incorporating the double venting structure 8, including the vent reservoir 9 and its vent tube 10 which cooperate with an internal vent 11, that is formed with the collar 7, and provides for venting of the fluids contained within its associated container (not shown) to allow for aeration free dispensing of said fluids out of its spout 12, that may include one or more of various slots 13 provided for varying the flow of the fluids to the consumer, at a degree of flow that is preferred by the user, when consuming such liquids, such as when participating in a sporting event, running a distance race, or for use for any related sporting events, as known in the art.

In referring to the concept of the current invention, and as disclosed in FIG. 2, therein can be seen the preferred embodiment for the invention as described. As noted, therein is disclosed a feeding nipple 14 having an integral flange 15 all as held in position by means of the collar 16 (partially shown) as applied to the type of nursing bottle, as previously explained at 2. The essence of the invention is the provision of designed slits, such as the short slits 17 that provide for a lower flow, or slow flow, of formula to the infant, and one or more longer slits, as at 18, that furnish a faster flow of fluid to the infant, during a feeding session.

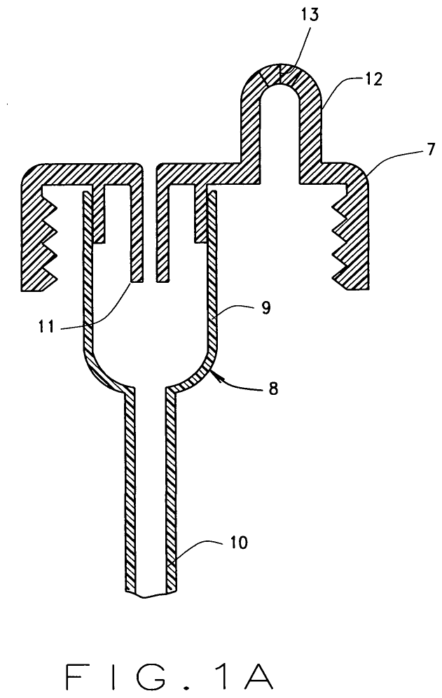

FIGS. 3 and 4 show front and back views of the nipple 14, as previously explained, and in the front view, of FIG. 3, it can be seen that the longer slits 18 are provided, and there is indicia inherently provided upon that face of the nipple that indicates that by placing the longer slits of the nipple downwardly within the infant's mouth, a faster flow, as noted at 19, may be experienced. Likewise, as noted in FIG. 4, when the shorter slits 17 are focused downwardly within the infant's mouth, a slower rate of flow can be arranged, and performed, indicated by the indicia as noted at 20. The size of the slits, their lengths, and the number of such slits, have previously been summarized within this application, to obtain the type of flow rates as previously reviewed and analyzed, through usage of the nursing bottle of this invention, incorporating slits of the type and sizes as defined herein.

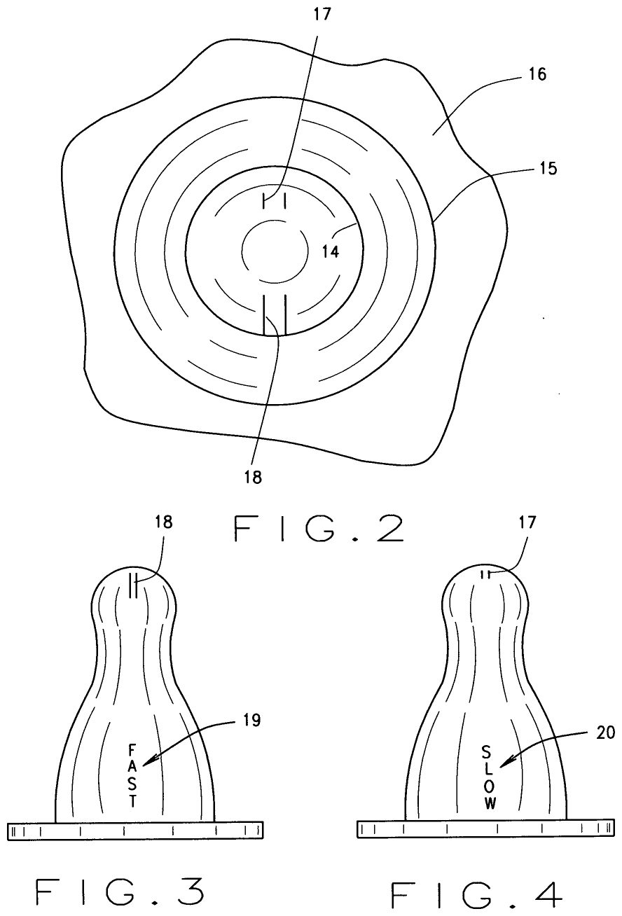

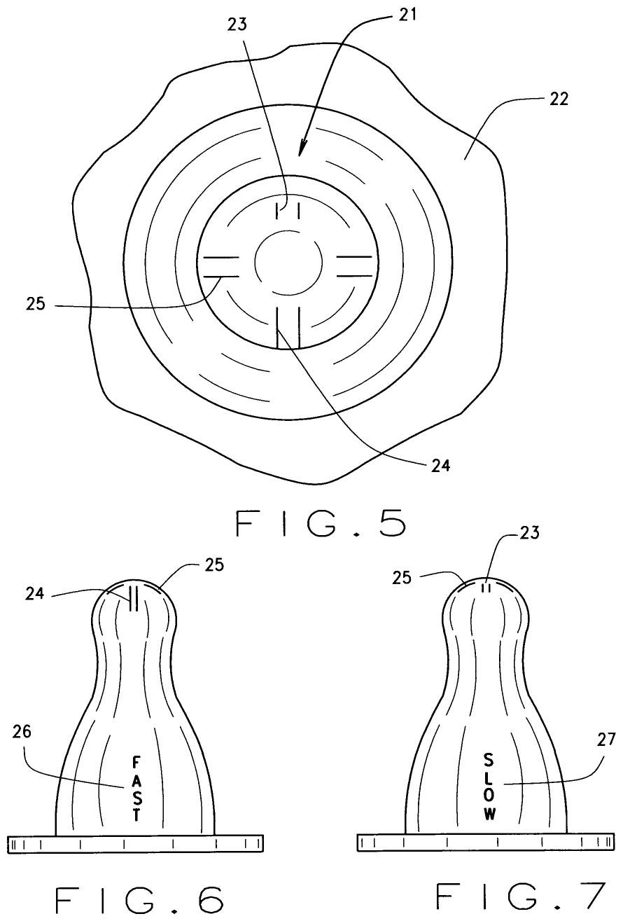

As can be noted in FIGS. 5-7, the nipple 21 is noted, and in this instance, provides for a three type rate of flow when the nipple is applied to its nursing bottle, through the use of a collar, such as partially noted at 22, in a manner as previously described. In this instance, there are a pair of short slits 23, a pair of long slits 24, and intermediate length slits 25, as noted. Thus, when the nursing bottle, with this type of designed nipple, having its various length slits is applied to the infant's mouth, a faster rate of flow can be attained, by placing the longer slits of the nipple within the infant's mouth lowermost therein, to induce a faster flow of formula, at the highest rate that can be obtained from a nipple of this design. FIG. 6 shows the longer slits 24, and its indicia 26, to indicate a faster flow rate during usage of the nursing bottle. Whereas FIG. 7 shows the usage of shorter slits within the nipple, as noted at 23, and indicia indicating that when the nipple is located in the infant's mouth with the short slits being downwardly disposed, a slower rate of flow will be obtained, noted by its indicia 27 as previously explained. Thus, a slow rate of flow can be obtained by locating the nipple of FIG. 7 downwardly within the infant's mouth during a feeding session. A fastest rate of flow can be obtained by placing the nipple of FIG. 6, downwardly within the infant's mouth, during a feeding session. But, by rotating the nipple 90 degrees, either way, the intermediate flow rate can be obtained by arranging the intermediate length slits 25, downwardly within the infant's mouth during a feeding session.

FIG. 8 shows a further modification to the nipple 28, wherein the rates of flow can be regulated through the orientation of the various longer slits 29, or shorter slits 30 as previously reviewed, but in this instance, some consistency of flow rate can also be obtained through the inclusion of an aperture 31 at the upper most apex of the nipple, which flow rate of formula through the aperture 31 will be supplemented by either a slow rate of flow enhanced by the short slits 30, or a higher rate of flow, induced by the arrangement of the longer slits 29, in the manner as previously described.

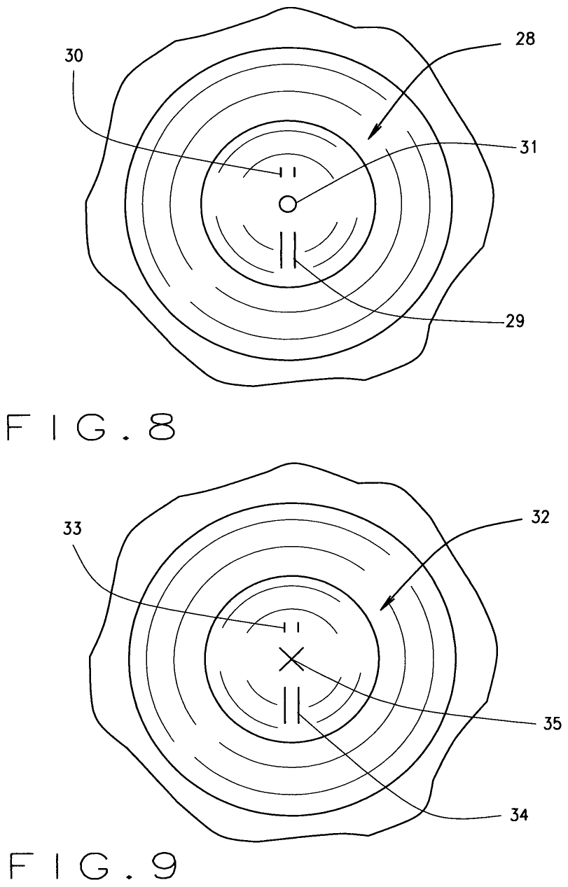

FIG. 9 shows a further modification to the nipple design, as noted at 32. In this instance, there are a pair of short slits 33 and longer slits 34, employed in the manner as previously described. In this instance, at the upper apex of the nipple is provided with a crosscut pair of slots 35 that function in the manner as previously explained, so as to furnish a constant flow of formula through the crosscut slits, as at 35, and which will be enhanced by either an additional slow rate of flow, through the short slit 33, or a greater rate of flow, through passage of the formula through longer slits 34, as explained.

FIG. 10 shows a nipple 36, having its short slits 37, and the longer slits 38, which complement and enhance the flow of formulate through the nipple, and out of its tangentially formed cross-slits 39 provided at the upper apex of the shown nipple, as can be noted.

FIG. 10A shows the arrangement of the tangentially formed cross slits 39, which generally provide for a cut of the slits along an angular incline, through the upper tip of the nipple, rather than perpendicularly cut slits, as normally done in the prior art. This provides for a more regulated flow of formula out of the nursing bottle, and through its nipple, and particularly through its tangentially formed cross slits, as can be understood. More variance and control of flow is noted with this arrangement.

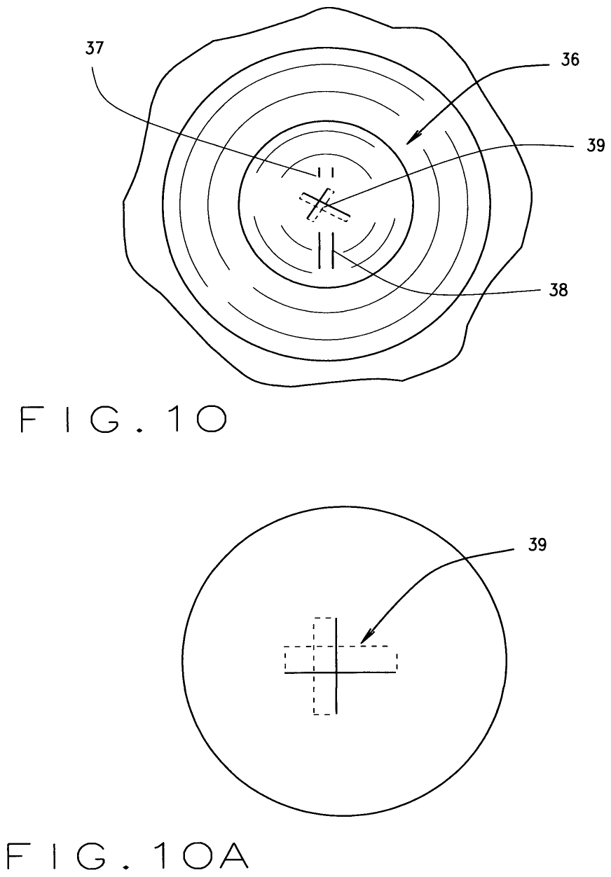

FIG. 11 shows a further variation upon the nursing bottle nipple 40 of this invention. It shows a variation of various slits, provided radially upon and through the nipple, and the slits include a short slit 41, a longest slit 42 generally provided opposite from the short slit, and then a series of intermediate slits 43-45, to provide for variations in the rate of flow of the formula through the nipple, and out of the same, during consumption. Obviously, to obtain these variations in flow rate, whatever rate is desired, that particular slit will be oriented downwardly within the infant's mouth, during a feeding session. In addition, there may be a cross slit 46 provided through the top of the nipple, in order to provide a consistent flow of formula from the nursing bottle, and which will be supplemented by variations in the flow rate, depending upon which of the slits 41-45 are oriented downwardly within the infant's mouth, during a feeding session.

A further variation upon the concept of this invention can be seen in the nipple design, as noted at 47, in FIG. 12. In this instance, it can be seen that there are three short slits 48 provided to one side of the nipple, radially disposed therethrough, and three long slits 49 are also provided opposite thereof. Thus, a faster flow can be obtained by orienting the three longer slits 49 downwardly within the infant's mouth, during feeding, or a slower rate of flow can be obtained, generally in the manner as previously summarized, with the orientation of the shorter slits 48 downwardly within the infant's mouth, during a feeding session. In addition, while three short and long slits are shown within this FIG. 12, and just a pair of such slits are shown in FIG. 2, it is just as likely that there may be a singular short slit, and a singular long slit, provided radially within the upper reaches of the nipple, or even more than three may be provided, depending upon the degree and volume of flow desired from the nipple, while feeding the infant. This is something the mother or caregiver will have to gauge, upon feeding the infant, in order to give the infant enough formula to satisfy its feeding requirements, or to slow it down to prevent the infant from consuming too much liquid, and gagging or choking in the process. It is regulated by the activities of the mother during the feeding session, by arranging the nursing bottle at some angular position, within the infant's mouth, to attain the flow rate that is most desirable and effective for the feeding infant, during a feeding session.

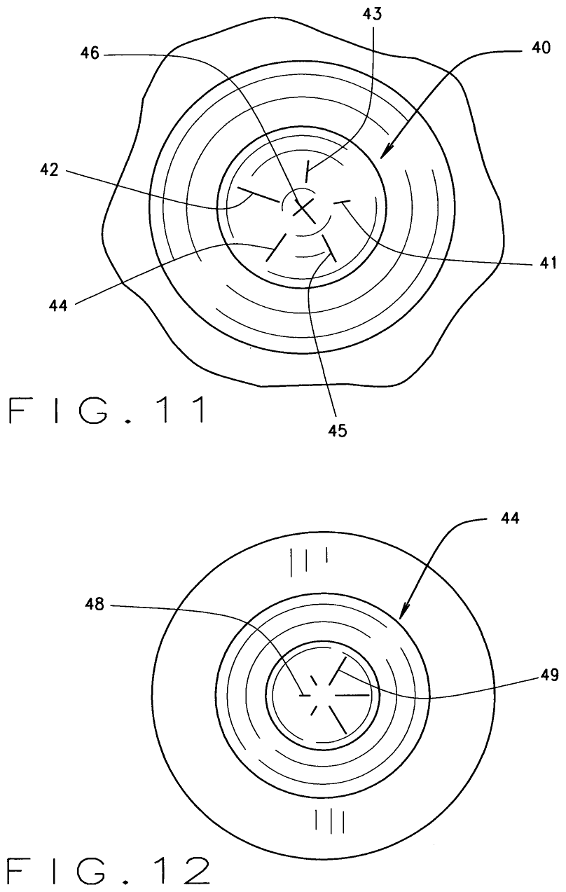

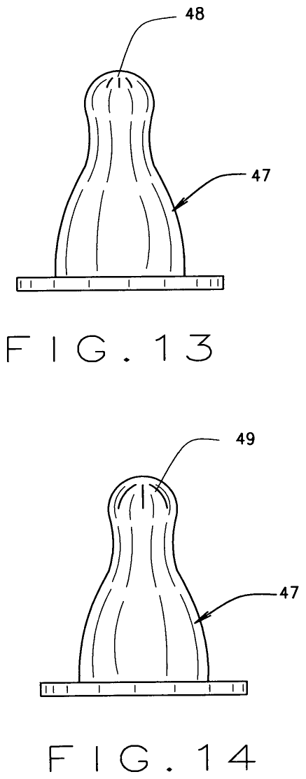

FIG. 13 provides a left side view of the nipple as disclosed in FIG. 12, showing the arrangement of the plurality of short slits 48 provided through the nipple. FIG. 14 shows a right side view of FIG. 12, showing the arrangement of the various long slits 49 provided within the nipple 47, to attain a greater rate of flow of the formula from the nursing bottle, during a feeding session.

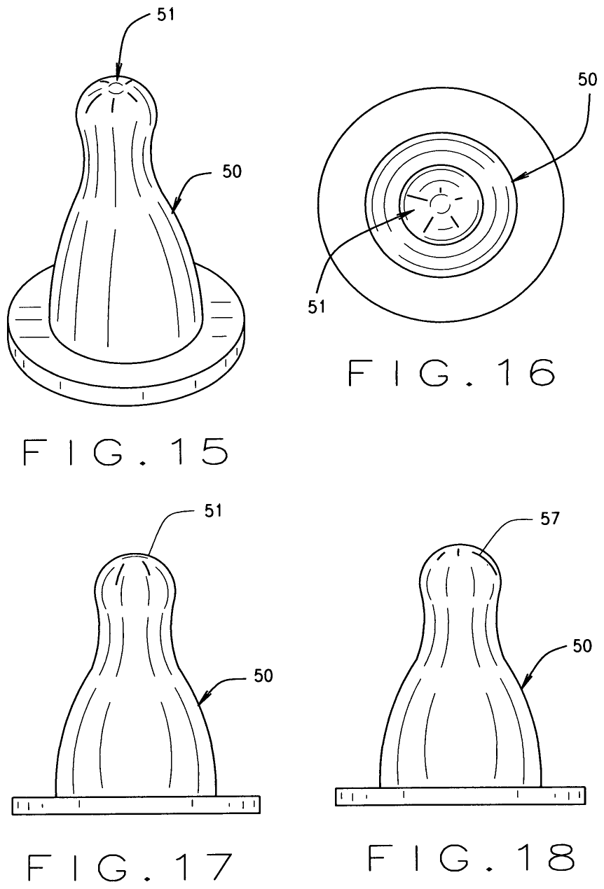

FIGS. 15-18 show the arrangement of a multitude of various length slits, formed radially within the upper regions of the shown nipple 50, as noted, the various slits are all of differing lengths, that allows for the mother to rotate the nursing bottle, into that position, that obtains a flow rate through the various slits 51 that appears to be most acceptable to the feeding infant, during a feeding session. The various lengths, orientation, and the amount of flow rate desired from the nipple will dictate, generally, the length of the slits to be provided through the upper regions of the nipple, in a manner as shown and described in these FIGS. 15-18.

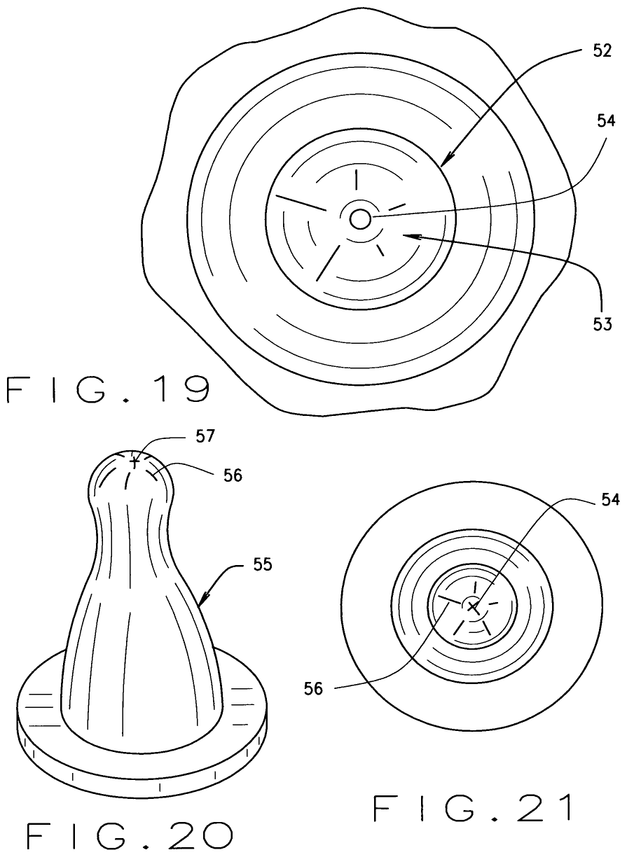

FIG. 19 shows a related nipple 52 having the various different lengths of slits 53, but in this arrangement, the structure of the nipple includes an upper centered aperture 54 to furnish a constant flow of formula from the nipple, and which may be supplemented by a rate of flow through the various slits 53, depending upon their orientation within the mouth of the feeding infant.

FIG. 20 shows the related structure for a nipple 55 having multi-length of radial slits 56 but in this instance having a crosscut 57 provided through the upper tip of the nipple, as can be noted. FIG. 21 provides an upper plan view of the nipple of FIG. 20, showing the arrangement of the crosscut slits 57 used in combination with the multiple length of slits 56 as previously explained.

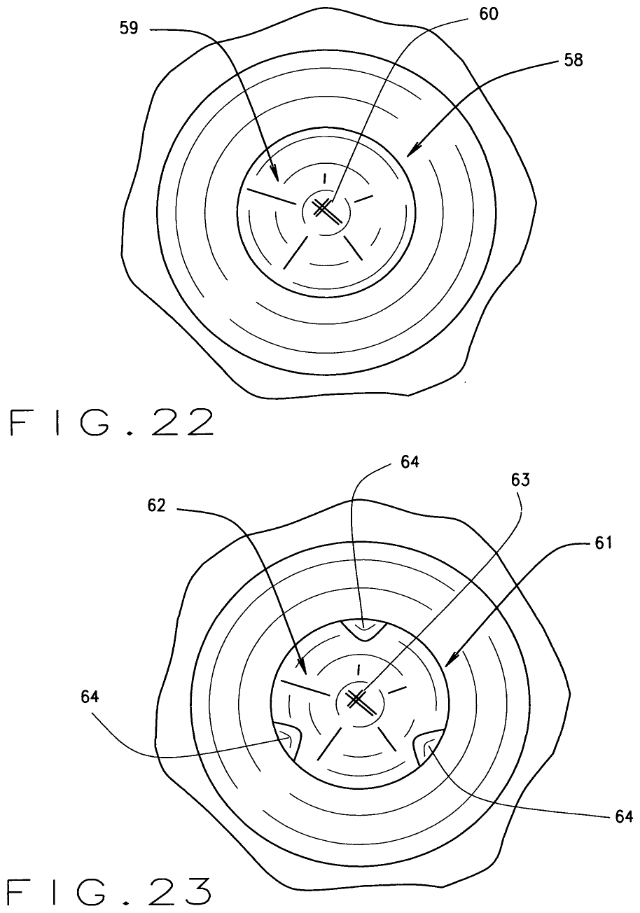

FIG. 22 show a further slight variation upon the nipple structure 58, showing the multi-length of slits radially disposed, at 59, but including tangentially cut cross slits 60 provided through the upper apex of the shown nipple, as can be understood.

Finally, FIG. 23 shows a further variation upon the nipple 61 showing the various multi-length of slits 62 the tangentially crosscut slits 63, and in this particular instance, internally provided within the nipple are a series of integrally formed reinforcing ribs 64, extending the height of the nipple, which prevents the collapse of the nipple during consumption of the nursing bottle contents, particularly since there are so many variations upon the slit structures, as at 62 and 63, provided through the upper regions of the nipple, such that the reinforcing ribs 64 help to prevent the collapse of the nipple, during formula consumption by the infant. As is well known, while the infant presses its mouth or gums against the nipple, and undertakes some degree of suction, this can lead towards nipple collapse, which is generally prevented through the use of the reinforcing ribs 64, as shown and identified herein. The venting also prevents collapse of the applied nipple.

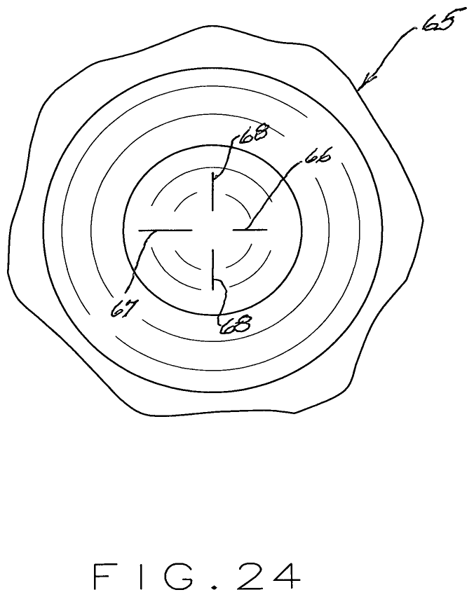

FIG. 24 shows another plan view of a modification to the variable flow nipple 65. As noted, it provides a singular short slit 66, a longer slit 67 opposite thereof, and a pair of intermediate length slits 68, as can be noted. Each of these slits can provide for a variable flow of the milk or formula from the associated nursing bottle.

Where the short slit 66 is provided at approximately a length of 0.4 mm to 0.8 mm, a flow may be provided in the amount of 40-62 drops per minute from the nursing bottle. Where the longer slit 67 is provided, and has a length of approximately 1.2 mm to 1.4 mm, or longer, the flow rate is in the range of 115-143 drops per minute. And, where intermediate slits, such as at 68, are provided, and these slits are approximately 0.8 mm to 1 mm in length, the flow rate from the nursing bottle is in the range of 83-111 drops per minute. Thus, depending upon the orientation of the nursing bottle within the infant's mouth, regulates the amount of liquid that flows from the bottle, during a feeding session. Hence, it leaves the mother or caregiver control of what type of flow may be attained from the nursing bottle, during a feeding. And, in the event that the nursing bottle is arranged at an angular position between any one of these identified slots, the amount of liquid flowing can be varied, and is variable, depending upon the location of the nursing bottle, and this formed nipple, directed towards the bottom of the infant's mouth, during a feeding session.

It might also be stated that when these various slits are provided within the nipple, as described throughout this application, where the slits are provided, they may be tapered at an angle, from the exterior, and thereby provide for better flow, and its control, of the liquid from the nursing bottle. And, where an aperture, such as at 31, is provided within the top of the nipple, if it is conically made, further provides for control of the flow of fluid from the nursing bottle.

Variations or modifications to the subject matter of this invention may occur to those skilled in the art upon review of the disclosure herein. Such variations, if within the spirit of this invention, are intended to be encompassed within the scope of any claims to patent protection issuing upon this development. The description of the invention in the specification, and its depiction in the drawings, are generally set forth for illustrative purposes only. It is the principle of the invention, as generally defined in the claims, that provide the scope of patent protection sought herein.

We claim:

1. A flow controllable and variable stream physiological dispenser for a nursing and related bottle, comprising:
a nipple having a top nipple portion which extends to an intermediate concaved section which extends to a lower dome-shaped body and integrally to a flange, the flange of the nipple used for holding the nipple to the nursing bottle by a collar;
said nipple having a first opening slit having a first length of a short dimension, a second opening slit having a second length of a greater dimension than said first opening slit, said first and second opening slits being radially disposed and approximately diametrically upon the nipple, said nipple having an opened bottom provided at the flange with the nipple having a hollow body through which a liquid may pass from the open bottom through the body and out of at least that opening slit provided downwardly of the nipple when applied to the mouth of a nursing infant;
said opening slits are orally activated to allow liquid to flow at a desired rate when pressure is applied to the nipple portion, and the lengths of each opening slit provided upon said nipple allowing for variable flow rates from said nipple, wherein the liquid flowing from the first opening slit is at a slower rate than the liquid flowing from the second opening slit when the nursing bottle is applied for feeding of an infant.

2. The variable flow nipple for a nursing bottle dispenser of claim 1, wherein there are a pair of parallel arranged first opening slits having the same short length provided through one side of the nipple, and a pair of second opening slits of a longer length and parallel arranged though the opposite side of said nipple, in order to control the rate of flow of formula from the nursing bottle during feeding of an infant.

3. The variable flow nipple for a nursing bottle dispenser of claim 1, wherein there are three parallel arranged first opening slits having a short length provided through one side of the nipple, and three second opening slits of a longer length and parallel arranged through the opposite side of said nipple, in order to control the rate of flow of formula from the nursing bottle during feeding of an infant.

4. The variable flow nipple for a nursing bottle dispenser of claim 1, wherein said nursing bottle is formed as a vented container to vent the interior of the bottle to atmosphere during feeding of the infant.

5. The variable flow nipple for a nursing bottle dispenser of claim 1, wherein there are more than three opening slits of the first length and more than three opening slits of the second length formed in said nipple.

6. The variable flow nipple for a nursing bottle dispenser of claim 1, and including a central opening provided at the apex of the nipple, and said central opening and the first and second opening slits are orally activated to allow liquid to flow at a desired rate when pressure is applied to the top nipple portion, and the first and second lengths of the opening slits being different from each other, to allow for the variable flow rates from said nipple at a controlled rate during an infant feeding session.

7. The variable flow nipple for a nursing bottle dispenser of claim 1, wherein the first opening slit provided through the nipple when located downwardly within the mouth of an infant providing for a lesser quantity of liquid being delivered from the nursing bottle to the infant during a feeding, and the second and longer opening slit being located downwardly within the mouth of an infant during feeding providing for a greater quantity of liquid being delivered from the container to the infant during a feeding.

8. The variable flow nipple for a nursing bottle dispenser of claim 6, wherein the central opening comprises a circular aperture.

9. The variable flow nipple for a nursing bottle dispenser of claim 6, bottle wherein said central aperture comprises a pair of cross slits formed at the apex of the nipple.

10. The dispenser of claim 9, wherein the cross cut slits are cut upon a tangent.

11. The dispenser of claim 9, wherein a cross cut slit is cut upon a tangent.

12. The dispenser of claim 9, wherein the openings are tiled shaped.

13. The dispenser of claim 1, wherein said bottle is a sports bottle.

14. The dispenser of claim 1, wherein indicia is applied to one of the nipple and nursing bottle identifying a full flow of fluid from the longest slit during an infant feeding, and indicia provided in alignment with the shortest slit opening in the nipple identifying the potential for obtaining a lowest flow of formula from the nipple and its nursing bottle during usage.

15. The dispenser of claim 1, and including reinforcing ribs provided within the interior of the nipple along its height to structurally strengthen the nipple against collapse during the feeding of an infant during usage of the nursing bottle.

16. The dispenser of claim 1, and there being at least one further slit of intermediate length between the first opening slit and the second opening slit, arranged at approximately 90 degrees from said first and second opening slits, in order to provide for an intermediate flow rate of liquid from the nursing bottle when feeding of an infant.

17. The dispenser of claim 1, wherein the first opening slit having a first length of a short dimension being in the range of approximately 0.4 mm to 0.6 mm, and the second opening slit having a second length of a greater dimension having a length of approximately at least 1.2 mm in length.

18. The dispenser of claim 16, wherein the first opening slit being of a length within the range of 0.4 mm to 0.8 mm, the slit of intermediate length having a length of approximately 0.8 mm to 1 mm in length, and the second opening slit of greater dimension having a length of at least 1.2 mm or longer.
